(19) United States
(12) Patent Application Publication
(10) Pub. No.: US 2023/0306206 A1
(43) Pub. Date: Sep. 28, 2023

(54) GENERATING RULES FOR MANAGING AN INFRASTRUCTURE FROM NATURAL-LANGUAGE EXPRESSIONS

(71) Applicant: NUTANIX, INC., San Jose, CA (US)

(72) Inventors: Debojyoti DUTTA, Santa Clara, CA (US); Rajat GHOSH, San Jose, CA (US)

(21) Appl. No.: 17/864,252

(22) Filed: Jul. 13, 2022

Related U.S. Application Data
(60) Provisional application No. 63/324,384, filed on Mar. 28, 2022.

(51) Int. Cl. G06F 40/40; G06F 40/284; G06F 11/34

(52) U.S. Cl. CPC G06F 40/40; G06F 40/284; G06F 11/3409

(57) ABSTRACT

In some embodiments, a method includes processing, by a machine learning model, a natural-language expression to generate one or more rules, each rule including a trigger and one or more actions; monitoring a deployed infrastructure to detect an occurrence of at least one of the one or more triggers of a first rule of the one or more rules; and performing at least one of the one or more actions of the first rule based on the occurrence of at least one of the one or more triggers.

### CROSS-REFERENCE TO RELATED APPLICATION

This application claims benefit of the U.S. Provisional Patent Application titled “ENHANCED IFTTT ENGINE FOR ERROR HANDLING,” filed Mar. 28, 2022, and having Ser. No. 63/324,384. The subject matter of this related application is hereby incorporated herein by reference.

### BACKGROUND

### Field of the Various Embodiments

The various embodiments relate generally to computing devices and, more specifically, to generating rules for managing an infrastructure from natural-language expressions.

### Description of the Related Art

Organizations such as universities and corporations often establish and maintain a complex infrastructure. For example, the information technology (IT) infrastructure of an organization can include a deployment of one or more file servers, one or more database servers, and one or more email servers. Organizations often record and maintain manifests of the components of the infrastructure. Organizations often monitor the components of the infrastructure to determine performance metrics, such as capacity, throughput, uptime, and/or the like. Also, organizations often monitor the components of the infrastructure to detect status indicators, such as stored resources and indications of wear, damage, failure, and/or the like.

In order to monitor the deployed infrastructure, some organizations create and apply a set of one or more rules, wherein each rule includes one or more triggers (e.g., a condition to be monitored) and one or more actions (e.g., steps to be performed based on an occurrence of the trigger). Some organizations apply the rules using a monitoring platform or service, such as If This Then That (IFTTT) service that is capable of associating a variety of triggers with a variety of actions. The monitoring platform or service can monitor the infrastructure based on the rules and perform one or more actions based on an occurrence of one or more triggers of one of the rules, as well as record logs of detection functions and errors that could arise during the monitoring.

One drawback of such techniques is the complexity involved in specifying the rules. As a first example, some platforms or services require triggers and actions to be specified in a defined format or language, such as a programming language (e.g. and without limitation, C, C++, Java, JavaScript, or Python). Users who are not familiar or comfortable with the defined format or language of the platform or service might be unable to create or edit the rules, or might create rules that do not operate as the users might expect. As a second example, some platforms or services provide a user interface for generating, reviewing, and editing rules, such as forms. However, forms can be cumbersome, which can add difficulty to the process of generating the rule set. Also, forms can require user training to ensure that the user understands how to use the controls and options of the forms. As a third example, some platforms or services can monitor and interact with common or standardized components, but might not be configured to monitor and interact with the particular components of an infrastructure, such as the specific set of servers of a particular organization. If a rule involves a particular server or a specific element of the server (e.g., an application or process running on the server), the platform or service might be unable to understand or monitor the one or more triggers of the rule and/or might be unable to understand or perform the one or more actions of the rule. In such cases, the service or platform might not correctly perform the monitoring. For example, the platform or service might not correctly detect an occurrence of the one or more triggers of the rule and/or might not correctly perform the one or more actions of the rule. Such failures can result in a malfunction or failure of one or more components of the infrastructure.

As the foregoing indicates, what is needed are more effective techniques for generating rules for managing an infrastructure.

### SUMMARY

One embodiment sets forth one or more non-transitory computer-readable media storing program instructions that, when executed by one or more processors, cause the one or more processors to perform a method. The method includes processing, by a machine learning model, a natural-language expression to generate one or more rules, each rule including a trigger and one or more actions; monitoring a deployed infrastructure to detect an occurrence of at least one of the one or more triggers of a first rule of the one or more rules; and performing at least one of the one or more actions of the first rule based on the occurrence of at least one of the one or more triggers.

Further embodiments provide, among other things, a method and a system for implementing the method described above.

At least one technical advantage of the disclosed techniques relative to the prior art is that, with the disclosed techniques, rules for monitoring a deployed infrastructure can be specified using natural-language expressions. By processing natural-language expressions to generate the rules, the machine learning model enables users to configure the rules of a monitoring engine for monitoring a deployed infrastructure using natural-language expressions, instead of more complex languages with which users might not be familiar. As a result, the rules can be created, reviewed, and updated more intuitively and naturally by administrators of the deployed infrastructure. Further, with the disclosed techniques, the machine learning model can accurately generate rules by processing natural-language expressions, whereas rules specified through programming language instructions or forms might include errors due to the complex format in which the rules are specified. Finally, processing natural-language expressions by a machine learning model can enable the rules to be specified based on the particular details of the deployed infrastructure (e.g., particular types of queries that arise within the infrastructure), whereas static or generic processing of natural-language expressions might be generically processed without accounting for such details. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the present embodiments;

FIG. 2 is an illustration of a portion of the machine learning model of the computer system of FIG. 1 according to various embodiments;

FIG. 3 is an illustration of a training pipeline of the machine learning model of FIG. 1 according to various embodiments;

FIG. 4 is an illustration of an architecture of the machine learning model of FIG. 1 according to various embodiments;

FIG. 5 is an illustration of a usage of the machine learning model according to various embodiments;

FIG. 6 illustrates a flow diagram of method steps for generating a system that generates rules from natural-language expressions, according to various embodiments;

FIG. 7 illustrates a flow diagram of method steps for processing natural-language expressions, according to various embodiments; and

FIGS. 8A-8D are block diagrams illustrating virtualization system architectures configured to implement one or more aspects of the present embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### Exemplary Computer System

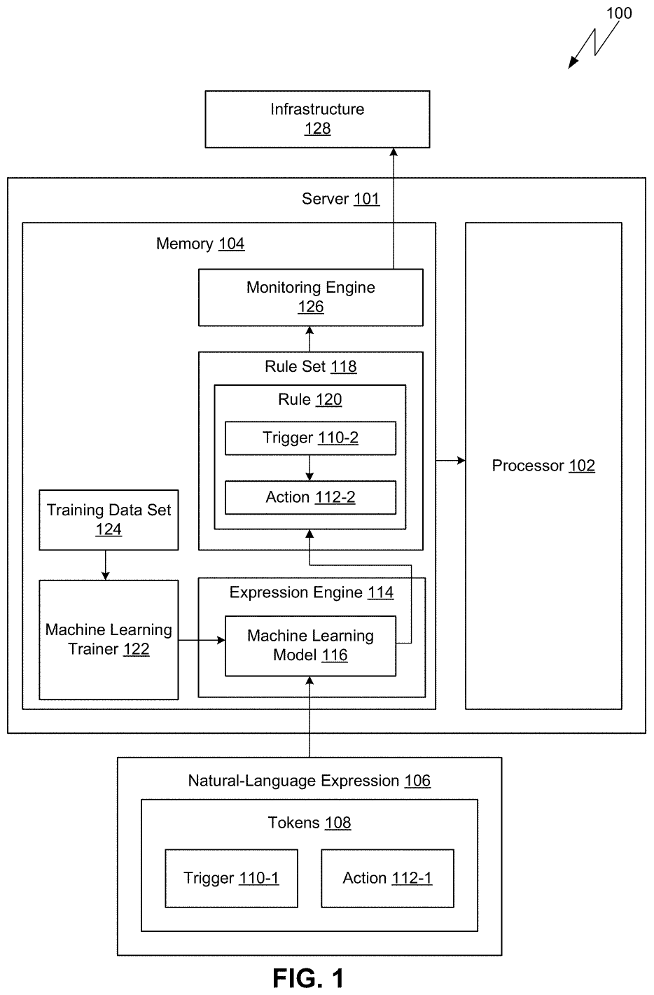

FIG. 1 is a block diagram illustrating a computer system 100 configured to implement one or more aspects of the present embodiments. As shown, a server 101 within computer system 100 includes, without limitation, a processor 102 and a memory 104. The memory 104 includes, without limitation, an expression engine 114, a rule set 118 including one or more rules 120, a machine learning trainer 122, a training data set 124, and a monitoring engine 126. The expression engine 114 includes a machine learning model 116.

The machine learning trainer 122 trains the expression engine 114 based on a training data set 124 to process natural-language expressions 106. In some embodiments, at least part of the training data set 124 is based on an infrastructure 128 deployed by an organization. For example, the training data set 124 can include details about the infrastructure 128, such as a list of servers, machines, pieces of equipment, or the like. In particular, the training data set 124 can include names or features of components of the infrastructure that an individual associated with the organization might mention in a natural-language expression 106, such as an infrastructure-specific name of a server. The training data set 124 can also be based on details of an organization that establishes, maintains, or uses the infrastructure 128, such as a natural language spoken by individuals of the organization, or a set of natural-language expressions 106 by the individuals of the organization. For example, the training data set can include the names of individuals who might be mentioned in an action portion of a natural-language expression, such as the name of a particular individual to notify of an occurrence of a trigger of a rule. In some embodiments, the expression engine 114 is partially pretrained to understand natural language expressions 106, and the machine learning trainer 122 completes the training of the machine learning model 116 based on the training data set 124. Training the machine learning model 116 on a training data set 124 associated with a particular infrastructure 128 can enable the machine learning model 116 to understand natural-language expressions 106 that are often used in connection with the particular infrastructure 128.

The expression engine 114 receives one or more natural-language expressions 106. Each natural-language expression 106 includes a set of tokens 108, such as dictionary words, names, and phrases. In particular, the natural-language expression 106 can include tokens that are associated with the deployed infrastructure, such as a name of a server or a name of an individual to notify of a trigger of a rule. Spoken natural-language expressions 106 might also include tokens 108 such as nonverbal utterances or timing features (e.g., pauses) that semantically affect the words, names, and phrases of the natural-language expression 106. Text-based natural-language expressions 106 might also include tokens 108 such as punctuation, mathematical symbols, or spacing that semantically affect the words, names, and phrases of the natural-language expression 106. The natural-language expression 106 can include one or more triggers 110-1 and one or more actions 112-1. For example, the natural-language expression 106 can include a set of tokens 108 (e.g., words, names, or phrases). Some of the tokens 108 specify one or more triggers 110-1, such as a condition to be monitored within the deployed infrastructure 128. Some examples of triggers 110-1 include “if the cluster has more than 100 API calls,” “if a health check of a server fails,” “if CPU utilization of a server exceeds 80%,” “if more than 25 out-of-memory errors occur within a month,” or “if monthly overhead exceeds a budget.” Some other tokens 108 can specify one or more actions 112-1 (e.g., words, names, or phrases that indicate one or more steps to be performed based on an occurrence of at least one of the one or more triggers). Some examples of actions 112-1 include “email an administrator,” “shut down a server,” “start one or more servers,” “run a memory auto-scaling process,” or “alert an administrator.” Still other tokens 108 of the natural-language expression 106 can be associated with neither the one or more triggers 110-1 nor the one or more actions 112, such as connecting terms that partition the one or more triggers 110-1 and the one or more actions 112-1 (e.g., “then”) or extraneous terms (e.g., “please”).

The expression engine 114 processes each received natural-language expression 106 by the trained machine learning model 116. In some embodiments, the expression engine 114 preprocesses the natural-language expression 106. For example, the expression engine 114 can apply speech processing techniques to translate a voice input including a natural-language expression 106 into a text-based natural-language expression 106. The machine learning model 116 segments the natural-language expression 106 into one or more trigger portions and one or more action portions. For example, the machine learning model 116 can determine which tokens 108 of the natural-language expression 106 are trigger tokens that are included in one or more triggers 110-1 of the natural-language expression 106, and which tokens 108 of the natural-language expression 106 are action tokens that are included in the one or more actions 112-1 of the natural-language expression 106.

The machine learning model 116 generates one or more rules 120 of the rule set 118 based on one or more natural-language expressions 106. Each rule 120 includes one or more triggers 110-2 (e.g., a condition to be monitored) and one or more actions 112-2 (e.g., one or more steps to be performed based on an occurrence of the one or more triggers 110-2). Based on the processed natural-language expression 106, the expression engine 114 adds one or more rules 120 generated by the machine learning model 116 to a rule set 118. In some embodiments, the natural-language expression 106 includes two or more triggers 110-1 associated with one or more actions 112-1, such as two or more alternative conditions to be monitored (e.g., “if the server crashes or the server is unreachable, then start a failover server”). The expression engine 114 can therefore add two or more rules 120 to the rule set 118 (e.g., “if the server crashes, then start a failover server” and “if the server is inaccessible, then start a failover server”). In some embodiments, the natural-language expression 106 includes one or more triggers 110-1 associated with two or more actions 112-1, such as two or more steps to be performed based on an occurrence of one or more triggers 110-1 (e.g., “if the server fails, then start a failover server and notify an administrator”). In some embodiments, the expression engine 114 can therefore add two or more rules 120 to the rule set 118 (e.g., “if the server fails, then start a failover server” and “if the server fails, then notify an administrator”). In some embodiments, one rule 120 can include two or more triggers 110, either as alternative triggers (e.g., coupled by a Boolean OR) or as connected triggers (e.g., coupled by a Boolean AND). In some embodiments, one rule 120 can include two or more actions 112 that are performed upon occurrence of the one or more triggers 110.

The monitoring engine 126 monitors the infrastructure 128 based on the one or more triggers 110-2 of the rules 120 of the rule set 118. Upon detecting an occurrence of one or more triggers 110-2 of a rule 120, the monitoring engine 126 performs the one or more actions 112-2 of the rule 120. For example, based on a rule 120 including a trigger 110-2 of “if the server crashes,” the monitoring engine 126 can monitor a server of the infrastructure 128 (e.g., a watchdog process that periodically queries the server and listens for a response). Upon detecting an occurrence of the one or more triggers 110-2 (e.g., the watchdog process determining that the server did not respond to a periodic query within a designed time limit), the monitoring engine 126 can perform an action 112-2 of “start a failover server” (e.g., transferring an allocation of resources or network mappings from the monitored server to an available failover server).

As shown, the expression engine 114, the machine learning trainer 122, and the monitoring engine 126 are included in the server 101. In various embodiments, these components could be distributed over two or more servers 101. For example, a first server 101 could train the machine learning model 116, a second server 101 could receive the machine learning model 116 and utilize it as part of an expression engine 114 to parse natural-language expressions 106 to generate the rule set 118, and a third server 101 could include the monitoring engine 126 that monitors an infrastructure 128 based on the rule set 118.

In various embodiments, the disclosed techniques are used to monitor conditions within a variety of infrastructures deployed by one or more organizations. Many aspects of monitoring such infrastructures 128 can be modeled as machine learning problems. In doing so, a machine learning model can be trained to perform certain types of monitoring for one or more systems of an infrastructure 128.

For example, an infrastructure 128 can include a number of virtual machines executing on one or more computing clusters, such as a Kubernetes cluster, in a manner that maximizes resource usage and availability of the different virtual machines. Each virtual machine within the Kubernetes cluster can use a different set of parameters and/or a different configuration (e.g., different resource allocations). A machine learning model 116 can be trained to parse natural-language expressions involving the one or more computing clusters. Alternatively or additionally, a trained machine learning model 116 can be deployed to one or more of the computing clusters. A machine learning model 116 can be trained to recognize natural-language expressions and/or to monitor conditions based on rules specified by natural-language expressions involving a virtual machine within a Kubernetes cluster, and, more particularly, based on the current resource utilization of virtual machines already deployed on the Kubernetes cluster.

A second infrastructure monitoring problem is predicting Kubernetes node resource exhaustion and scaling the cluster accordingly. In some embodiments, each node within a Kubernetes cluster of an infrastructure 128 can feature a different resource utilization. A machine learning model 116 can be trained to recognize natural-language expressions and/or to monitor conditions based on rules specified by natural-language expressions that involve a cluster scaling action based on the current resource utilization of the nodes within the Kubernetes cluster of the infrastructure 128.

A third infrastructure monitoring problem is efficiently scheduling applications and services to execute within one or more computing clusters of an infrastructure 128, such as Kubernetes clusters. In some embodiments, each node in an infrastructure 128 is associated with a different set of component resource consumption metrics indicating the resource consumption of different applications and/or services executing within the multiple Kubernetes clusters. A machine learning model 116 can be trained to recognize natural-language expressions and/or to monitor conditions based on rules specified by natural-language expressions that involve deploying an application or service to run on a selected Kubernetes cluster and/or removing an application or service from a selected Kubernetes cluster of the infrastructure 128 based on the current applications and services that are executing within a Kubernetes system of the infrastructure 128.

A fourth infrastructure monitoring problem is performance tuning on various microservices deployed on one or more computing clusters of an infrastructure 128, such as one or more Kubernetes clusters. A machine learning model 116 can be trained to recognize natural-language expressions and/or to monitor conditions based on rules specified by natural-language expressions that involve performing performance tuning on the microservices deployed within a Kubernetes system of the infrastructure 128 based on the current request rates and latencies of the microservices deployed within the Kubernetes system of the infrastructure 128.

A fifth infrastructure monitoring problem is minimizing service mesh pairwise latency within a computing system of an infrastructure 128, such as a Kubernetes system. A machine learning model 116 can be trained to recognize natural-language expressions and/or to monitor conditions based on rules specified by natural-language expressions that involve performing an action that reduces service mesh pairwise latency within a Kubernetes system of the infrastructure 128 based on the current network traffic within the Kubernetes system of the infrastructure 128.

As can be seen in the above examples, when monitoring an infrastructure 128, the rules that can be generated and/or monitored based on natural-language expressions can be prohibitively large. Training a machine learning model 116 using the entirety of natural-language expressions would require a significant amount of time and computational resources. Accordingly, using the approaches discussed here, training the machine learning model 116 based on the details of a particular infrastructure 128 can greatly reduce the amount of time and computational resources needed to train the machine learning model 116 and/or the performance that can be achieved by the trained machine learning model 116.

Various embodiments include varying architectures of the machine learning model 116. For example (without limitation), the machine learning model 116 can include an encoding layer, wherein the encoding layer maps each natural-language word of a language to an identifier (e.g., a unique integer). The machine learning model 116 can include a number of inputs that correspond to the number of words in the language. The machine learning model 116 can process a natural-language expression 106 by first partitioning the natural-language expression 106 into tokens. For example, the machine learning model 116 can split the natural-language expression 106 based on words and punctuation, thus generating a sequential list of tokens (e.g., individual words). The machine learning model 116 can then map a first token of the list to an identifier, based on the encoding layer, and provide a one-hot encoding as input to an input layer of the machine learning model 116. The one-hot encoding is a vector of a length matching the length of the input layer of the machine learning model 116. The values of the vector are the value 1 for an input corresponding to the unique integer of the first token of the natural-language expression 106 and the value 0 for inputs corresponding to all words of the language other than the first word. The machine learning model can receive the one-hot encoding of a first token of the natural-language expression (e.g., the encoding of the first token generated by the encoding layer) and generate, as output, an indication of whether the first token is a trigger token 108 or an action token 108. In some embodiments, the machine learning model 116 also updates an internal state, such as a value of one or more parameters, based on the first token and/or the output of the machine learning model 116. Next, the machine learning model 116 can similarly process a second token of the list based on the internal state of the machine learning model 116 in response to the first token. In this manner, the machine learning model 116 sequentially processes the words of a natural-language expression 106 to determine whether each token is a trigger token 108 or an action token 108.

In some embodiments, the architecture of the machine learning model 116 includes various numbers of inputs and outputs. For example (without limitation), the machine learning model 116 can be configured to receive, as input, one token of a natural-language expression 106 (e.g., an encoding of one word of the natural-language expression 106) and generates, as output, a likelihood that the one token is a trigger token 108 or an action token 108. Alternatively, the machine learning model 116 can be configured to receive, as input, two or more tokens of a natural-language expression 106 (e.g., encodings of each word of two or more words of the natural-language expression 106) and determines a likelihood that each token of the two or more tokens is a trigger token 108 or an action token 108. For example, the machine learning model 116 can segment a natural-language expression 106 into two or more phrases. Each phrase of the natural-language expression includes two or more words that are likely to be similarly classified as either a trigger token 108 or an action token 108. The machine learning model 116 can concurrently evaluate multiple words, such as two or more words included in one phrase of the natural-language expression 106. The machine learning model 116 can generate one or more outputs indicating whether the words of the phrase are trigger tokens 108 or action tokens 108. In various embodiments, the machine learning model 116 includes one output for the phrase (e.g., a per-phrase classification of all of the words of the phrase as either a trigger token 108 or an action token 108), a number of outputs that corresponds to the number of words in the phrase (e.g., a per-word classification of each word of the phrase as either a trigger token 108 or an action token 108), or another number of outputs.

In some embodiments, the architecture of the machine learning model 116 includes a variety of components that aid the processing of natural-language expressions 106. In various embodiments, the machine learning model 116 includes a transformer-based machine learning model 200, in which a transformer includes one or more attention heads. Each attention head indicates, for a first token of a natural-language expression 106, which other tokens of the natural-language expression 106 are likely to affect a meaning of the first token and/or a classification of the first token as either a trigger token 108 or an action token 108. For example, in a first natural-language expression 106 such as “if a server is down, then notify a client,” while processing the tokens respectively corresponding to the words “a server is down,” the attention head indicates the token corresponding to the word “if” likely affects the classification of these tokens as being trigger tokens 108. Similarly, while processing the tokens respectively corresponding to the words “notify a client,” the attention head indicates the token corresponding to the word “then” likely affects the classification of these tokens as being action tokens 108.

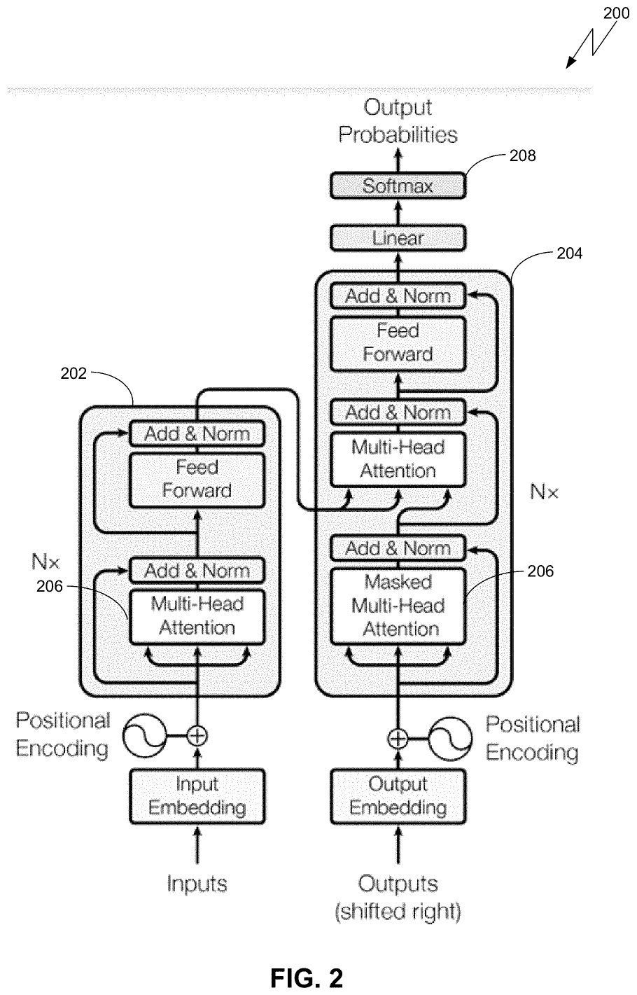

FIG. 2 is an illustration of a portion of the machine learning model 116 of the computer system of FIG. 1 according to various embodiments. As shown, the transformer-based machine learning model 200 includes an encoder 202 and a decoder 204.

In some embodiments, the machine learning model 116 includes a transformer-based machine learning model 200 that processes natural-language expressions 106 based on one or more attention heads 206. The transformer-based machine learning model 200 includes an encoder 202 that receives, for each portion (e.g., each token) of a natural-language expression provided as input, a language embedding that encodes the portion of the natural language expression 106. The encoder 202 also receives, for each portion of the natural-language expression 106, a position encoding that encodes the position of the portion within the natural-language expression 106. Based on the language embedding and the positional encoding, the encoder 202 generates an attention encoding that indicates a significance of the portion to a current position of the natural-language expression 106. The transformer-based machine learning model 200 also includes a decoder 204 that evaluates one or more output embeddings. The decoder 204 receives, from the encoder 202, the language embedding, the positional encoding, and the attention encoding of each portion of the natural-language expression 106 preceding the current position. Based on the language embeddings, the positional encodings, and the attention encodings of the portions of the natural-language expression 106 preceding the current position, the decoder 204 generates, for the current position of the natural-language expression 106, an output probability of each output embedding for the current position. The transformer-based machine learning model 200 includes a softmax activation layer 208 that normalizes the output probabilities into a normal probability distribution. Based on this architecture, the transformer-based machine learning model 200 can determine the output embeddings with the highest probability of occurring at the current position of the natural-language expression 106 based on the previous portions of the natural-language expression 106.

In some embodiments, the machine learning model 116 can include the transformer-based machine learning model 200 to process the natural-language expressions 106. For example, the output embeddings can include a first output embedding indicating trigger tokens and a first output embedding indicating action tokens. The transformer-based machine learning model 200 can classify each token 108 of a natural-language expression 106 as a trigger token or an action token. For example, the transformer-based machine learning model 200 can process each token 108 by the encoder 202, along with any previous tokens 108 of the natural-language expression 106. The decoder 204 receives the input embeddings, positional encodings, and attention encodings of the current token and any previous tokens and generates (via the softmax activation layer 208) output probabilities of the token for the first output embedding indicating a trigger token and the second output embedding indicating an action token. Based on the output probabilities, the transformer-based machine learning model 200 can determine a trigger portion of the natural-language expression 106 including the trigger tokens and an action portion of the natural-language expression 106 including the action tokens. The transformer-based machine learning model 200 can exclude or discard any tokens for which the output probabilities of being a trigger token or an action token are poor. In this manner, the transformer-based machine learning model 200 can segment the natural-language expression 106 into a trigger portion and an action portion in accordance with some embodiments.

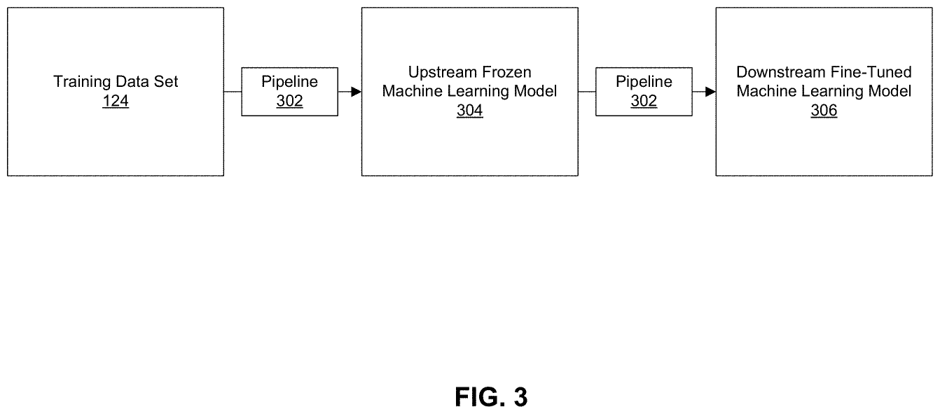

FIG. 3 is an illustration of a training pipeline of the machine learning model 116 of FIG. 1 according to various embodiments. As shown, the training pipeline includes a training data set 124, an upstream frozen machine learning model 304, and a downstream fine-tuned machine learning model 306.

As shown, the training pipeline receives an upstream frozen machine learning model 304. The upstream frozen machine learning model 304 includes, for example, a machine learning model that is pretrained to parse natural-language expressions 106. The upstream frozen machine learning model includes parameters that are initially fixed based on the pretraining, to perform initial processing of natural-language expressions that can be further processed by additional layers and/or training to adapt the pretraining to a particular usage. For example, the upstream frozen machine learning model 304 can include a bidirectional encoder representation (BERT) machine learning model, which includes the transformer-based machine learning model 200 (such as shown in FIG. 2) is pretrained on a natural language corpus and a classification layer following the transformer-based machine learning model 200. The upstream frozen machine learning model 304 can be selected from a library of upstream frozen machine learning models 304, each having been pretrained on a different natural language (e.g., English, Spanish, or French). The upstream frozen machine learning model 304 has been trained to process classifying words or phrases of a natural-language expression 106, for example, to determine the attention encodings of various words or phrases in preceding portions of a natural-language expression 106 with regard to a current position of the natural-language expression 106. However, the upstream frozen machine learning model 304 might not be trained to perform a particular classification task, such as classifying tokens of a natural-language expression 106 as either trigger tokens or action tokens.

The training pipeline 302 includes a training data set 124. For example, the training data set 124 can include natural-language expressions 106 in which respective tokens 108 are labeled as either a trigger token 108 or an action token 108. In some embodiments, the training data set 124 can include a generic set of natural-language expressions 106. Alternatively or additionally, the training data set 124 can be based on an infrastructure 128. For example, the training data set 124 can include a set of particular natural-language expressions 106 that are specific to a particular infrastructure 128. The machine learning trainer 122 implements the training pipeline 302 by training the upstream frozen machine learning model 304 using the training data set 124 to generate a downstream fine-tuned machine learning model 306. In some embodiments, the machine learning trainer 122 appends, to the upstream frozen machine learning model 304, one or more additional layers (e.g., one or more fully-connected layers).

In some embodiments, the one or more additional layers include an output layer. The output layer includes a first output that indicates a likelihood that a token of a natural-language expression 106 is a trigger token 108 and a second output that indicates a likelihood that a token of a natural-language expression 106 is an action token 108. In some embodiments, the output layer includes a softmax activation function, which scales a value of the first output and a value of the second output to fit a probability distribution. For example, the output layer can scale the value of the first output and the value of the second output such that the sum of the values is at least approximately 100%. As another example, the machine learning model 116 can include a perceptron output that outputs, for each token, a value between at least 0 and 1. Tokens for which the output value is below a threshold (e.g., the value 0.5) can be classified as trigger tokens 108, and tokens for which the output value is above the threshold can be classified as action tokens 108. In some embodiments, the distance of the output value from the threshold indicates a confidence of the classification. For example, values close to 0 indicate a high confidence in the classification of the token as a trigger token 108. Values close to 1 indicate a high confidence in the classification of the token as an action token 108. Values close to 0.5 indicate a poor confidence of the classification of the token as either a trigger token 108 or an action token 108.

The machine learning trainer 122 trains the machine learning model 116 based on the training data set 124. In some embodiments, the machine learning trainer 122 initializes at least a portion of the machine learning model 116 (e.g., by randomizing values of one or more parameters of the machine learning model 116). The machine learning trainer 122 processes each natural-language expression 106 of the training data set 124 by the machine learning model to determine an output for each token of the natural-language expression 106 (e.g., a likelihood or probability of a classification of the token as a trigger token 108 or an action token 108).

The machine learning trainer 122 compares the output for each token with a corresponding label of the token in the training data set 124. If the output of the machine learning model 116 indicates a classification of a token that matches the corresponding label of the token in the training data set 124, the machine learning trainer 122 determines that the machine learning model 116 correctly classified the token. If the output of the machine learning model 116 indicates a classification of a token that does not match the corresponding label of the token in the training data set 124, or if the output fails to indicate either classification, the machine learning trainer 122 determines that the machine learning model 116 incorrectly classified the token. In response to determining that the machine learning model 116 incorrectly classified the token, the machine learning trainer 122 updates the weights and/or biases of the one or more additional layers of the machine learning model 116 to improve the classification of the token. During the updating, the machine learning model 116 holds a set of lower layers of the upstream frozen machine learning model 304 frozen (e.g., not updating the weights and biases of the lower layers). In some embodiments, the machine learning trainer 122 collects and aggregates changes to the weights and/or biases for a plurality of natural-language expressions of the training data set 124 (e.g., a batch of the training data set 124). After processing the batch, the machine learning trainer 122 updates the weights and/or biases of the machine learning model 116 based on the aggregated changes of the batch.

The machine learning trainer 122 trains the machine learning model 116 through one or more batches and/or “epochs” or passes through the training data set 124. Periodically (e.g., after each epoch), the machine learning trainer 122 determines a training progress of the machine learning model 116. For example, the machine learning trainer 122 can determine the accuracy rate with which the machine learning model 116 correctly classifies the natural-language expressions of the training data set 124. In some embodiments, the machine learning trainer 122 determines the training progress as a training measurement, such as an entropy value or loss value, wherein lower entropy values or loss values indicate a degree of concurrence between the outputs of the machine learning model 116 and the corresponding labels of the training data set 124. In some embodiments, the machine learning trainer 122 compares the training measurement with a training measurement threshold (e.g., an accuracy threshold). If the training measurement does not satisfy the training measurement threshold (e.g., if the entropy value or loss value is not below the threshold), the machine learning trainer 122 continues training, such as performing another epoch of the training using the training data set 124. If the training measurement satisfies the training measurement threshold (e.g., if the entropy value or loss value is below the threshold), the machine learning trainer 122 determines that the training of the machine learning model 116 is complete. The machine learning trainer 122 then outputs the machine learning model 116 as a downstream fine-tuned machine learning model 306 that is trained to segment the natural-language expression 106 into a trigger portion and an action portion. As another example, the machine learning trainer 122 can compare the training measurement for a current batch and/or epoch of the training with the training measurement of a previous batch and/or epoch. If the machine learning trainer 122 determines that the training measurement has not improved based on a current batch and/or epoch of the training relative to the entropy value or loss value of a previous batch or epoch, the machine learning trainer 122 concludes that the training of the machine learning model 116 is complete (e.g., to avoid overtraining the machine learning model 116).

In various embodiments, the machine learning trainer 122 uses different portions of the training data set 124 for training the machine learning model 116 and for testing the machine learning model 116 to determine a completion of the training. For example (without limitation), the machine learning trainer 122 can partition the training data set 124 into a first set of natural-language expressions 106 and corresponding labels for training the machine learning model 116 and a second set of natural-language expressions 106 and corresponding labels for testing the machine learning model 116. The machine learning trainer 122 can train the machine learning model 116 based on the first set of natural-language expressions 106. After a batch or epoch, the machine learning trainer 122 can determine the training progress and training measurement of the machine learning model 116 based on the second set of natural-language expressions 106.

After the completion of the training, the machine learning trainer 122 can deploy the downstream fine-tuned machine learning model 306. In various embodiments, a first server trains the machine learning model 116, and then deploys the downstream fine-tuned machine learning model 306 to a second server including an expression engine 114. The second server receives natural-language expressions 106, processes natural-language expressions 106 by the downstream fine-tuned machine learning model 306, and generates one or more rules 120 to comprise or be added to a rule set 118. The second server can deploy the rule set 118 to a third server that includes a monitoring engine 126, and the third server can monitor the deployed infrastructure to detect the occurrence of one or more rules of the rule set 118.

In some embodiments, the machine learning trainer 122 retrains and/or redeploys the downstream fine-tuned machine learning model 306. As an example, a change can occur in the deployed infrastructure and/or the rule set 118 by which the deployed infrastructure is to be monitored, wherein the change requires an update of the downstream fine-tuned machine learning model 306. As another example, the downstream fine-tuned machine learning model 306 might experience model drift, in which the downstream fine-tuned machine learning model 306 exhibits diminished performance in processing natural-language expressions 106 to generate rules 120. In these and other cases, the machine learning trainer 122 can reinitiate training of the machine learning model 116 or can perform additional training of the downstream fine-tuned machine learning model 306. After a completion of the retraining or additional training, the machine learning trainer 122 configures a monitoring engine 126 to use the updated downstream fine-tuned machine learning model 306 and/or redeploys the updated downstream fine-tuned machine learning model 306 to one or more other servers.

In some embodiments, the machine learning model 116 processes the tokens 108 of the natural-language expression 106 using a different architecture. The machine learning model 116 can include a BERT machine learning model, wherein each BERT layer includes a transformer-based machine learning model 200 and one or more classification layers. In some embodiments, the machine learning model 116 includes two or more BERT layers. For example, the machine learning model 116 can include a deep neural network, a recurrent neural network, a long-term short-term-memory (LSTM) network, a gated recurrent unit (GRU) network, or a generative pre-trained (GPT) network, such as a GPT-1, GPT-2, or GPT-3 network.

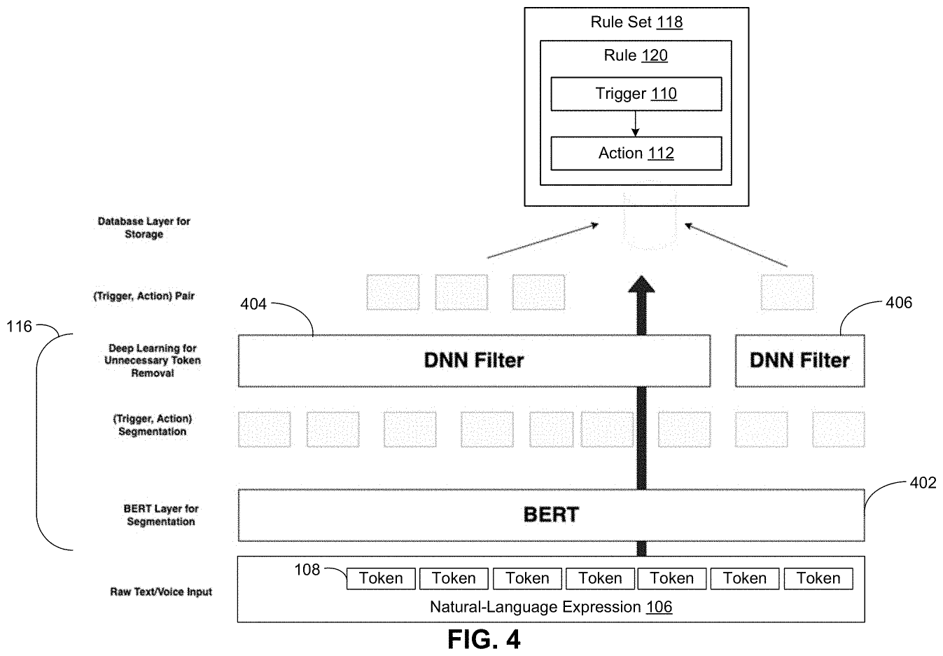

FIG. 4 is an illustration of an architecture of the machine learning model of FIG. 1 according to various embodiments. The machine learning model 116 includes, without limitation, a BERT machine learning model 402, a first deep neural network (DNN) layer 404, and a second deep neural network (DNN) layer 406.

As shown, the BERT machine learning model 402 receives a natural-language expression 106 including a set of tokens 108. The BERT machine learning model 402 includes a transformer-based machine learning model 200. The BERT machine learning model 402 determines whether each token 108 of the natural-language expression 106 is a trigger token or an action token. For example, the BERT machine learning model 402 determines that a token 108 is a trigger token if a trigger output probability generated by the softmax activation layer 208 for the token 108 is greater than an action output probability of the token 108. The BERT machine learning model 402 determines that a token 108 is an action token if the trigger output probability of the token 108 is less than the action output probability of the token 108. In some embodiments, the BERT machine learning model 402 determines that a token 108 is neither a trigger token nor an action token if the first and second output probabilities are below an output probability threshold.

In some embodiments, the machine learning model 116 determines, for each token of the natural-language expression, a confidence score indicating a classification confidence of the token as being one of a trigger token or an action token. For example, the confidence scores can be based on the output probabilities of the softmax activation layer 208 that indicate whether each token 108 is a trigger token 108 or an action token 108. The classification score can be, for example, a magnitude of a difference between a trigger output probability of a token 108 and an action output probability of the token 108. In some embodiments, the machine learning model 116 classifies each of one or more tokens 108 as a trigger token or an action token when the confidence score is above a confidence score threshold. If the confidence score of a token 108 is not above a confidence score threshold, the machine learning model 116 excludes or discards the token 108 and/or asks a user to indicate whether the token 108 is a trigger token 108 or an action token 108.

Based on the output of the BERT machine learning model 402, the first DNN layer 404 receives the trigger tokens 108 and generates a trigger 110-2 of a rule 120. The first DNN layer 404 translates one or more trigger tokens 108 of the natural-language expression 106 into the trigger 110 of one or more rules 120. The second DNN layer 406 receives the action tokens 108 and generates one or more actions 112-2 of the rule 120. The second DNN layer 406 translates one or more action tokens 108 of the natural-language expression 106 into the one or more actions 112 of one or more rules 120. For example, the trigger 110-2 and the one or more actions 112-2 can be specified in a rule format that is compatible with a monitoring platform such as IFTTT. The rule format can be, for example, a JSON rule format, an XML rule format, and/or the like. The expression engine 114 generates a rule 120 that includes the generated trigger 110-2 and the one or more actions 112-2. The expression engine 114 adds the generated rule 120 to the rule set 118 for use by the monitoring engine 126.

In some embodiments, the first DNN layer 404 and the second DNN layer 406 are the same machine learning model 116, or are duplicate instances of the same machine learning model 116. In other embodiments, the first DNN layer 404 and the second DNN layer 406 are different machine learning models 116. For example, the first DNN layer 404 can be trained on a first training data set including trigger tokens 108 associated with labels that indicate the corresponding triggers 110 of rules 120. The second DNN layer 406 can be trained on a second training data set including action tokens 108 associated with labels that indicate the corresponding one or more actions 112 of rules 120. In various embodiments, one or both of the DNN layers filters is configured to exclude, from the tokens 108 received from the BERT machine learning model 402, one or more tokens 108 of the natural-language expression 106 that are not classified as a trigger token or an action token. For example, the excluding can be based on the confidence scores of the classification of the respective tokens 108.

In some embodiments, the first DNN layer 404 generates one trigger 110 based on a trigger portion of a natural-language expression 106, and the second DNN layer 406 generates two or more actions 112 based on an action portion of the natural-language expression 106. As a result, the machine learning model 116 generates a first rule 120 including the trigger 110 and a first action 112, and also a second rule 120 including the trigger 110 and a second action 112.

In some embodiments, the first DNN layer 404 generates two or more triggers 110 based on a trigger portion of a natural-language expression 106, and the second DNN layer 406 generates one action 112 based on an action portion of the natural-language expression 106. As a result, the machine learning model 116 generates a first rule 120 including a first trigger 110 and the action 112, and also a second rule 120 including a second trigger 110 and the action 112.

In some embodiments, the machine learning model fails to generate one or more rules 120 based on the natural-language expression 106. For example, the BERT machine learning model 402 could fail to identify one or more tokens 108 as trigger tokens, and/or could fail to identify one or more tokens 108 as action tokens. Alternatively or additionally, the first DNN layer 404 could fail to generate a trigger 110 based on the one or more trigger tokens, and/or the second DNN layer 406 could fail to generate one or more actions based on the one or more action tokens. Based on a failure of the machine learning model 116 to generate one or more rules 120 for the natural-language expression 106, the machine learning trainer 122 could retrain the machine learning model 116. For example, the machine learning trainer 122 could identify the natural-language expression 106 as being ambiguous or difficult to process with a sufficient classification confidence. Based on receiving one or more labels that identify the tokens 108 as trigger tokens or action tokens, the machine learning trainer 122 could retrain the BERT machine learning model 402. Based on receiving a trigger 110 of the rule 120 to be generated based on the trigger tokens, the machine learning trainer 122 could retrain the first DNN layer 404. Based on receiving one or more actions 112 of the rule 120 to be generated based on the action tokens, the machine learning trainer 122 could retrain the first DNN layer 404.

Alternatively or additionally, in some embodiments, the first DNN layer 404 generates a rule 120 including two or more triggers 110 based on a trigger portion of a natural-language expression 106 and one or more actions 112 based on an action portion of the natural-language expression 106. The two or more triggers 110 could be alternative triggers 110 (e.g., coupled by a Boolean OR), wherein the monitoring engine 126 executes the one or more actions 112 based on an occurrence of either one of the triggers 110. The two or more triggers 110 could be connected triggers 110 (e.g., coupled by a Boolean AND), wherein the monitoring engine 126 executes the one or more actions 112 based on an occurrence of both of the triggers 110. In some embodiments, a rule 120 can include two or more triggers 110 and also two or more actions 112.

Alternatively or additionally, in some embodiments, the first DNN layer 404 generates a rule 120 including one or more triggers 110 based on a trigger portion of a natural-language expression 106 and two or more actions 112 based on an action portion of the natural-language expression 106. The monitoring engine 126 executes all of the two or more actions 112 based on an occurrence of the trigger 110.

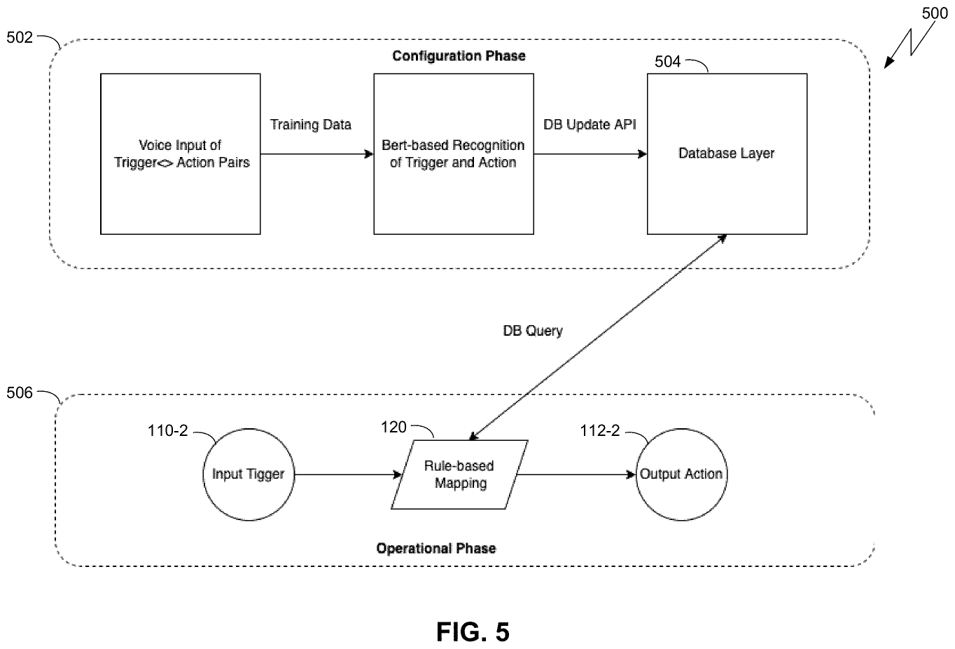

FIG. 5 is an illustration of a usage 500 of a machine learning model according to various embodiments. For example, the machine learning model can be machine learning model 116. As shown, the usage 500 includes a configuration phase 502 and an operational phase 506.

During the configuration phase 502, an expression engine 114 creates a rule set 118 of rules 120 based on one or more natural-language expressions 106. The machine learning trainer 122 receives a training data set 124 and trains the machine learning model 116 to generate rules 120 based on the training data set 124. In some embodiments, the expression engine 114 receives one or more voice inputs from a user, each including one or more triggers 110-2 and one or more actions 112-1. The expression engine 114 processes each voice input of the voice inputs (as a natural-language expression 106) by a BERT machine learning model 402 to generate one or more rules 120. The expression engine 114 stores the one or more rules 120, for example, in a database layer 504. In some examples, the expression engine 114 also presents the one or more rules 120 to the user to verify or clarify the understanding of the rules 120 expressed in the voice inputs and the one or more rules 120 generated therefrom.

During the operational phase 506, a monitoring engine 126 monitors an infrastructure 128 to detect an occurrence of one or more triggers 110-2 of a first rule 120 of the one or more rules. For example, the one or more triggers 110-2 can include a threshold or pattern of activity in a monitored computer system or a network, and the monitoring engine 126 monitors resource utilization of the computer system or network to detect the occurrence of the one or more triggers 110-2. Based on a detected occurrence of the one or more triggers 110-2, the monitoring engine 126 performs the one or more actions 112-2 associated with the one or more triggers 110-2 of the first rule 120.

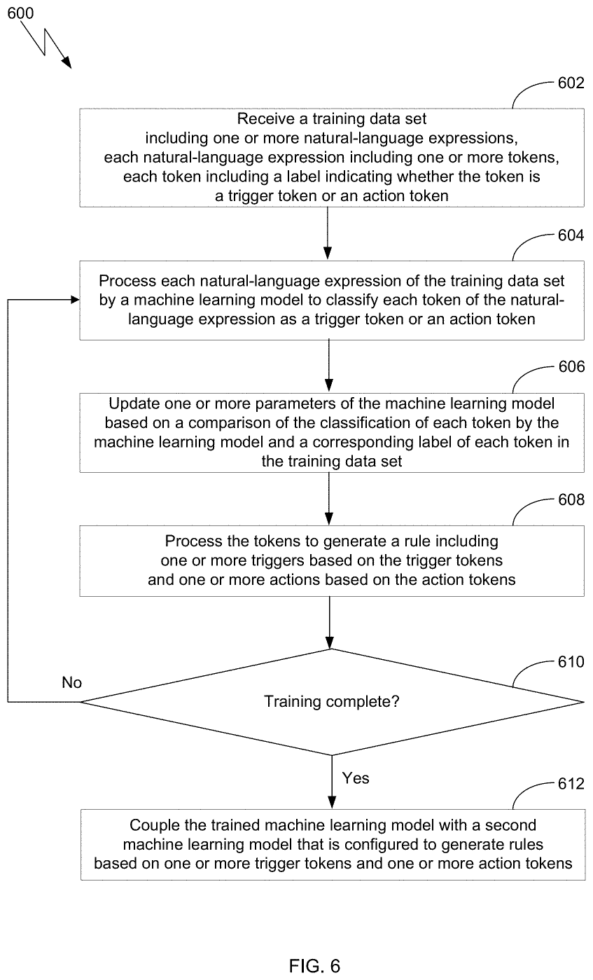

FIG. 6 illustrates a flow diagram of method steps for generating a system that generates rules from natural-language expressions, according to various embodiments. The method steps of FIG. 6 can be performed, for example, by the machine learning trainer 122 of FIG. 1 to generate rules 120 for a rule set 118 for an infrastructure 128. In some embodiments, the method steps of FIG. 6 are performed during the configuration phase 502 of FIG. 5.

As shown, a method 600 begins at step 602 in which the machine learning trainer receives a training data set including one or more natural-language expressions. Each natural-language expression includes one or more tokens. Each token includes a label indicating whether the token is a trigger token or an action token. In various embodiments, the tokens of the training data set are based on a deployed infrastructure. For example, the tokens of the training data set can include names or features of components of the deployed infrastructure that an individual associated with the organization might mention in a natural-language expression, such as an infrastructure-specific name of a server. In various embodiments, at least one of the natural-language expressions of the training data set includes two or more triggers. The triggers can be specified in the alternative (e.g., a Boolean OR) or can be connected (e.g., a Boolean AND). In various embodiments, at least one of the natural-language expressions of the training data set includes two or more actions that are to be performed in response to an occurrence of the one or more triggers of the rule.

At step 604, the machine learning trainer processes each natural-language expression of the training data set by a machine learning model. In various embodiments, the machine learning model is configured to receive one or more tokens as input and to generate, as output, a likelihood that each of the one or more tokens is either a trigger token or an action token. In various embodiments, the machine learning model includes a perceptron output that outputs, for each token, a value between at least 0 and 1. Tokens for which the output value is below a threshold (e.g., the value 0.5) can be classified as trigger tokens, and tokens for which the output value is above the threshold can be classified as action tokens. In various embodiments, the machine learning model includes a transformer-based machine learning model, such as a BERT machine learning model. In various embodiments, the BERT machine learning model is pretrained or partially trained on a natural language corpus, and the machine learning model includes a classification layer following the transformer-based machine learning model that is trained by the machine learning trainer using the training data set. Based on an output of the machine learning model for each token of the natural-language expression, the machine learning trainer classifies each token of the natural-language expression as a trigger token or an action token. In various embodiments, the machine learning model can exclude or discard any tokens for which the output probabilities of being a trigger token or an action token are poor.

At step 606, the machine learning trainer updates one or more parameters of the machine learning model. The update is based on a comparison of the classification of each token by the machine learning model and a corresponding label of each token in the training data set. When the machine learning model incorrectly classifies a token as a trigger token or an action token, the machine learning trainer can adjust a weight and/or a bias of one or more neurons in one or more layers of the machine learning model so that the machine learning model instead generates the correct classification of the token. The update changes the processing of the token by the machine learning model so that the machine learning model correctly classifies the token as the other of the trigger token and the action token. In various embodiments, the machine learning model includes an upstream frozen machine learning model, such as a pretrained BERT machine learning model, followed by a classification layer. The update adjusts the weights and/or biases of the classification layer to cause the machine learning model to generate correct classifications of the tokens.

At step 608, the machine learning trainer determines a training progress of the machine learning model. In various embodiments, the machine learning model generates a training measurement of the machine learning model and a training measurement threshold. In various embodiments, the training measurement includes an entropy value or loss value based on the comparisons of the classification of the tokens and the corresponding labels in the training data set. In various embodiments, the machine learning trainer determines that training is complete when the measured entropy value or loss value is below a training measurement threshold. In various embodiments, the machine learning trainer determines that training is complete when the measured entropy value or loss value at the completion of a training epoch or batch does not reduce the measured entropy value or loss value at the completion of a previous training epoch or batch. If the machine learning trainer determines 610, based on the training progress, that training is not complete, the machine learning trainer returns to step 604. In various embodiments, the machine learning trainer processes one or more additional batches and/or epochs of training and measures additional entropy values or loss values at the completion of the one or more additional batches and/or epochs. If the machine learning trainer determines 610, based on the training progress, that training is complete, the method proceeds to step 612.

At step 612, the machine learning trainer couples the trained machine learning model with a second machine learning model that is configured to generate rules based on one or more trigger tokens and one or more action tokens. In various embodiments, the second machine learning model includes one or more DNN layers. In various embodiments, the second machine learning model is pretrained to generate one or more triggers of a rule based on one or more trigger tokens, and/or is pretrained to generate one or more actions of a rule based on one or more action tokens. Alternatively, in various embodiments, the machine learning trainer also trains the second machine learning model. For example, the machine learning trainer can receive a second training data set of training data samples. Each training data sample of the second training data set can associate one or more trigger tokens with one or more triggers of a rule to be generated from the one or more trigger tokens, and/or can associate one or more action tokens with one or more actions of a rule to be generated from the one or more action tokens. The machine learning trainer can train the second machine learning model in a similar manner as discussed with regard to the machine learning model, such as steps 604-614. In either case, the machine learning trainer can couple an output of the trained machine learning model (e.g., the one or more trigger tokens and the one or more action tokens) to an input of a trained second machine learning model. By this process, the machine learning trainer generates a system that is configured to generate rules from natural-language expressions. In various embodiments, the computer system configures a monitoring engine to use the generated system to process natural-language expressions. Alternatively or additionally, in various embodiments, the computer system deploys the trained machine learning model to another device (e.g., another server) including a monitoring engine.

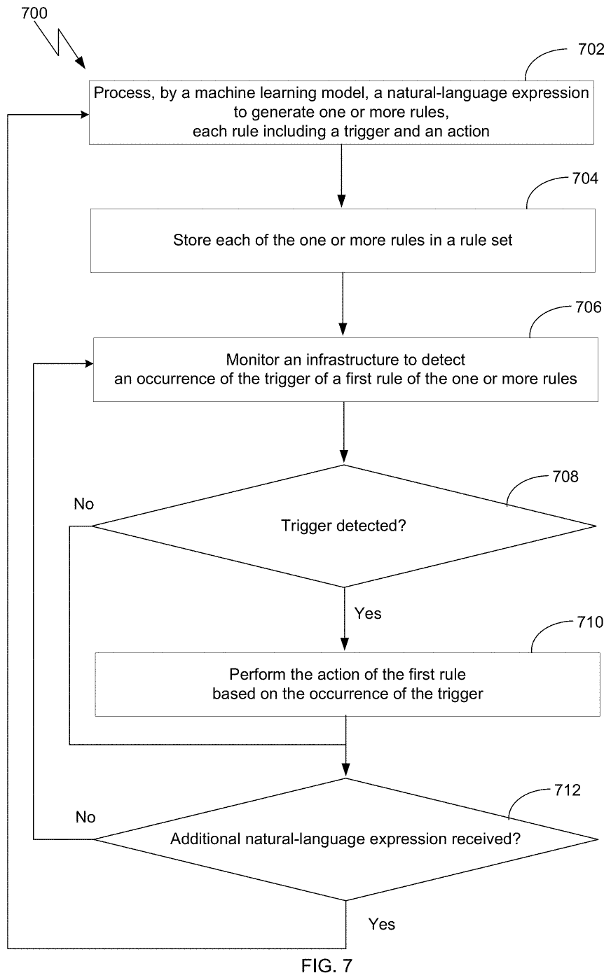

FIG. 7 illustrates a flow diagram of method steps for processing natural-language expressions, according to various embodiments. The method steps of FIG. 7 can be performed, for example, by the expression engine 114, including the machine learning model 116, and/or the monitoring engine 126 of FIG. 1 to generate rules 120 for a rule set 118 for an infrastructure 128. The method steps of FIG. 7 can also be performed during the operational phase 506 of FIG. 5.

As shown, a method 700 begins at step 702 in which the expression engine processes, by a machine learning model, a natural-language expression to generate one or more rules, each rule including one or more triggers and one or more actions. In some embodiments, the expression engine processes one or more verbal or text-based natural-language expressions by a machine learning model to generate one or more rules. In various embodiments, the machine learning model includes a BERT machine learning layer that has been pretrained or partially trained on a natural language corpus; a classification layer following the transformer-based machine learning model that have been trained by a machine learning trainer using the training data set; and one or more DNN layers that have been trained by the machine learning trainer to generate rules based on the classification of the tokens. In various embodiments, the machine learning model has been trained based on a training data set that includes names or features of components of the deployed infrastructure that an individual associated with the organization might mention in a natural-language expression, such as an infrastructure-specific name of a server. That is, in various embodiments, the machine learning model has been trained to generate rules based on the particular features of the deployed infrastructure. In various embodiments, the expression engine processes the natural-language expressions during a configuration phase to generate a rule set of rules to be monitored.

At step 704, the expression engine stores the one or more rules generated by the machine learning model. In various embodiments, the expression engine stores the one or more rules in a database layer, such as a database layer. In various embodiments, the expression engine stores the rules during a configuration phase.

At step 706, the computer system monitors an infrastructure to detect an occurrence of the one or more triggers of a first rule of the one or more rules. For example, the monitoring engine can monitor one or more servers to detect a failure or unavailability of one of the servers. If the computer system determines during step 708 that the one or more triggers of the first rule have not occurred, the method proceeds to step 712. If the computer system determines during step 708 that the one or more triggers of the first rule have occurred, the method proceeds to step 710. In various embodiments, one or more rules can include two or more triggers, that are specified in the alternative (e.g., a Boolean OR), and the monitoring engine determines that the rule has been triggered based on an occurrence of any one of the triggers. In various embodiments, one or more rules can include two or more triggers that are connected (e.g., a Boolean AND), and the monitoring engine determines that the rule has been triggered based on an occurrence of all of the two or more triggers. In various embodiments, the computer system monitors the infrastructure during an operational phase.

At step 710, the monitoring engine performs the one or more actions of the first rule based on the occurrence of at least one of the one or more triggers. Upon detecting that one or more conditions indicated in the trigger portion of one of the generated rules have occurred, the monitoring engine can perform the one or more actions indicated in the action portion of the rule. For example, based on an occurrence of a failure of one or more servers, the monitoring engine can notify an administrator as to the occurrence of the failure of the server. In various embodiments, a rule can include two or more actions, and the monitoring engine can perform all of the two or more actions based on an occurrence of one or more trigger conditions of the rule.

At step 712, the expression engine determines whether an additional natural-language expression have been received. If not, the monitoring engine returns to step 708 to continue the monitoring of the infrastructure. If so, the computer system returns to step 702 so that the expression engine can process the additional natural-language expression to generate and store one or more additional rules. In various embodiments, based on the additional natural-language expression, the machine learning trainer detects drift of the machine learning model, or that the machine learning model cannot generate rules based on the additional natural-language expressions. Based on the additional natural-language expression, the machine learning trainer can retrain the machine learning model, such as by the method of FIG. 6. The machine learning trainer can also redeploy the retrained machine learning model at the conclusion of the retraining to one or more servers that include a monitoring engine.

### Exemplary Virtualization System Architectures

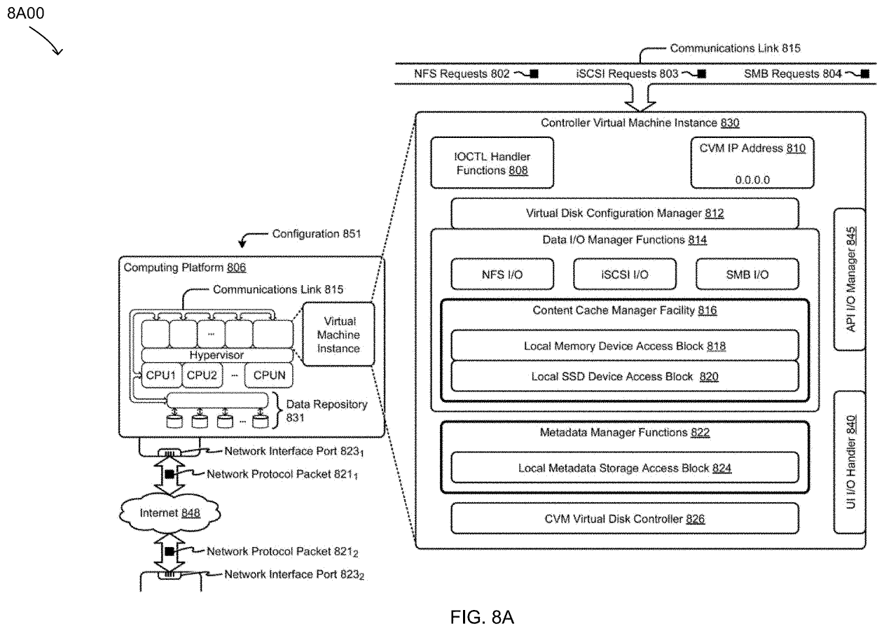

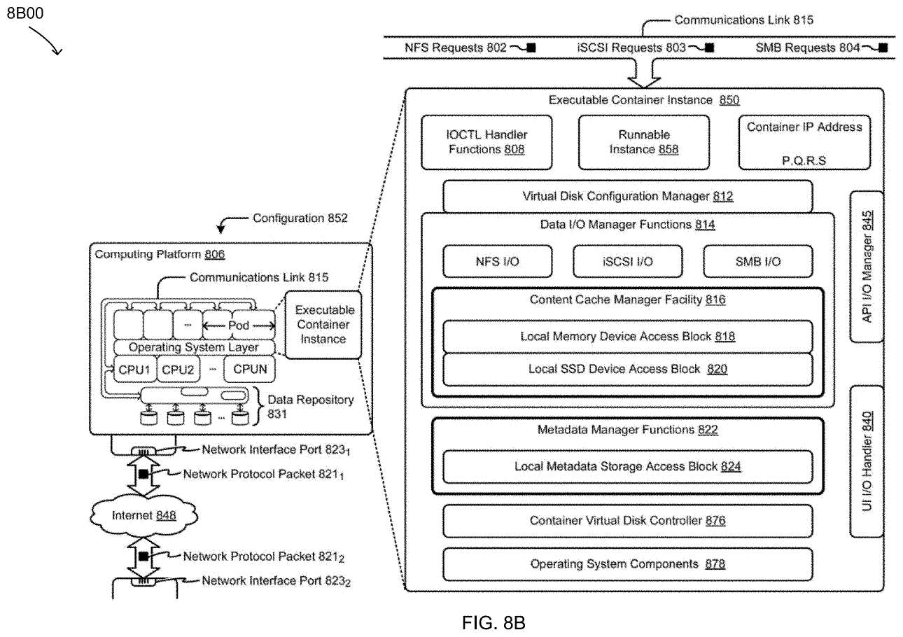

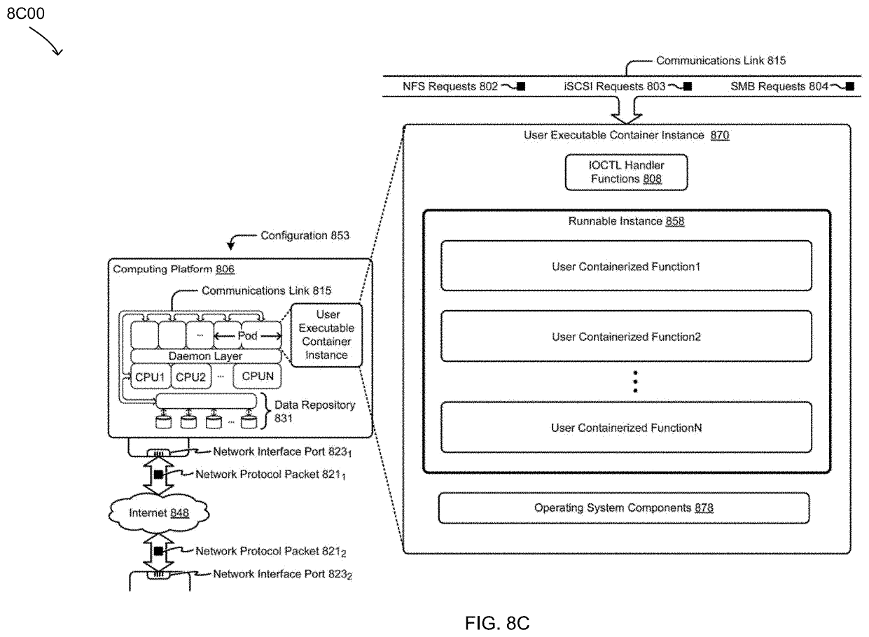

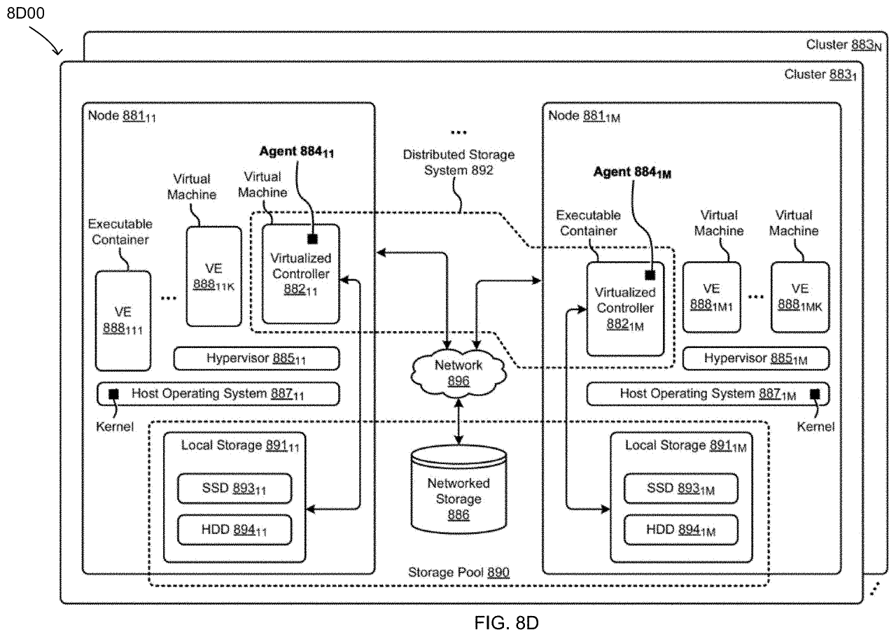

FIG. 8A is a block diagram illustrating virtualization system architecture 8A00 configured to implement one or more aspects of the present embodiments. As shown in FIG. 8A, virtualization system architecture 8A00 includes a collection of interconnected components, including a controller virtual machine (CVM) instance 830 in a configuration 851. Configuration 851 includes a computing platform 806 that supports virtual machine instances that are deployed as user virtual machines, or controller virtual machines or both. Such virtual machines interface with a hypervisor (as shown). In some examples, virtual machines may include processing of storage I/O (input/output or IO) as received from any or every source within the computing platform. An example implementation of such a virtual machine that processes storage I/O is depicted as CVM instance 830. Any of the virtualization system architectures shown in FIGS. 8A-8D can include the server 101 of FIG. 1. Any of the virtualization system architectures shown in FIGS. 8A-8D can execute the method of FIG. 6 or the method of FIG. 7. Any of the virtualization system architectures shown in FIGS. 8A-8D can also be included in the monitored infrastructure.

In this and other configurations, a CVM instance receives block I/O storage requests as network file system (NFS) requests in the form of NFS requests 802, internet small computer storage interface (iSCSI) block IO requests in the form of iSCSI requests 803, Samba file system (SMB) requests in the form of SMB requests 804, and/or the like. The CVM instance publishes and responds to an internet protocol (IP) address (e.g., CVM IP address 810). Various forms of input and output can be handled by one or more IO control handler functions (e.g., IOCTL handler functions 808) that interface to other functions such as data IO manager functions 814 and/or metadata manager functions 822. As shown, the data IO manager functions can include communication with virtual disk configuration manager 812 and/or can include direct or indirect communication with any of various block IO functions (e.g., NFS IO, iSCSI IO, SMB IO, etc.).

In addition to block IO functions, configuration 851 supports IO of any form (e.g., block IO, streaming IO, packet-based IO, HTTP traffic, etc.) through either or both of a user interface (UI) handler such as UI IO handler 840 and/or through any of a range of application programming interfaces (APIs), possibly through API IO manager 845.

Communications link 815 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), formatting of bit fields into fixed-length blocks or into variable length fields used to populate the payload, and/or the like. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

Computing platform 806 includes one or more computer readable media that is capable of providing instructions to a data processor for execution. In some examples, each of the computer readable media may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random-access persistent memories (RAPMs) or optical or magnetic media drives such as paper tape or magnetic tape drives. Volatile media includes dynamic memory such as random-access memory (RAM). As shown, controller virtual machine instance 830 includes content cache manager facility 816 that accesses storage locations, possibly including local dynamic random-access memory (DRAM) (e.g., through local memory device access block 818) and/or possibly including accesses to local solid-state storage (e.g., through local SSD device access block 820).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 831, which in turn can be formatted into any one or more storage areas, and which can comprise parameterized storage accessible by a key (e.g., a filename, a table name, a block address, an offset address, etc.). Data repository 831 can store any forms of data and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 824. The data repository 831 can be configured using CVM virtual disk controller 826, which can in turn manage any number or any configuration of virtual disks.

Execution of a sequence of instructions to practice certain of the disclosed embodiments is performed by one or more instances of a software instruction processor, or a processing element such as a data processor, or such as a central processing unit (e.g., CPU₁, CPU₂, . . . , CPU_{N}). According to certain embodiments of the disclosure, two or more instances of configuration 851 can be coupled by communications link 815 (e.g., backplane, LAN, PSTN, wired or wireless network, etc.) and each instance may perform respective portions of sequences of instructions as may be required to practice embodiments of the disclosure.

The shown computing platform 806 is interconnected to the Internet 848 through one or more network interface ports (e.g., network interface port 823₁ and network interface port 823₂). Configuration 851 can be addressed through one or more network interface ports using an IP address. Any operational element within computing platform 806 can perform sending and receiving operations using any of a range of network protocols, possibly including network protocols that send and receive packets (e.g., network protocol packet 821₁ and network protocol packet 821₂).

Computing platform 806 may transmit and receive messages that can be composed of configuration data and/or any other forms of data and/or instructions organized into a data structure (e.g., communications packets). In some cases, the data structure includes program instructions (e.g., application code) communicated through the Internet 848 and/or through any one or more instances of communications link 815. Received program instructions may be processed and/or executed by a CPU as it is received and/or program instructions may be stored in any volatile or non-volatile storage for later execution. Program instructions can be transmitted via an upload (e.g., an upload from an access device over the Internet 848 to computing platform 806). Further, program instructions and/or the results of executing program instructions can be delivered to a particular user via a download (e.g., a download from computing platform 806 over the Internet 848 to an access device).

Configuration 851 is merely one example configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

In some embodiments, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to management of block stores. Various implementations of the data repository comprise storage media organized to hold a series of records and/or data structures.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT,” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT,” issued on Oct. 1, 2013, which is hereby incorporated by reference in its entirety.

FIG. 8B depicts a block diagram illustrating another virtualization system architecture 8B00 configured to implement one or more aspects of the present embodiments. As shown in FIG. 8B, virtualization system architecture 8B00 includes a collection of interconnected components, including an executable container instance 850 in a configuration 852. Configuration 852 includes a computing platform 806 that supports an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http:”) and possibly handling port-specific functions. In some embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

The operating system layer can perform port forwarding to any executable container (e.g., executable container instance 850). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “Is” or “Is -a”, etc.). The executable container might optionally include operating system components 878, however such a separate set of operating system components need not be provided. As an alternative, an executable container can include runnable instance 858, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 876. Such a container virtual disk controller can perform any of the functions that the aforementioned CVM virtual disk controller 826 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 8C is a block diagram illustrating virtualization system architecture 8C00 configured to implement one or more aspects of the present embodiments. As shown in FIG. 8C, virtualization system architecture 8C00 includes a collection of interconnected components, including a user executable container instance in configuration 853 that is further described as pertaining to user executable container instance 870. Configuration 853 includes a daemon layer (as shown) that performs certain functions of an operating system.

User executable container instance 870 comprises any number of user containerized functions (e.g., user containerized function₁, user containerized function₂, . . . , user containerized function_{N}). Such user containerized functions can execute autonomously or can be interfaced with or wrapped in a runnable object to create a runnable instance (e.g., runnable instance 858). In some cases, the shown operating system components 878 comprise portions of an operating system, which portions are interfaced with or included in the runnable instance and/or any user containerized functions. In some embodiments of a daemon-assisted containerized architecture, computing platform 806 might or might not host operating system components other than operating system components 878. More specifically, the shown daemon might or might not host operating system components other than operating system components 878 of user executable container instance 870.

In some embodiments, the virtualization system architecture 8A00, 8B00, and/or 8C00 can be used in any combination to implement a distributed platform that contains multiple servers and/or nodes that manage multiple tiers of storage where the tiers of storage might be formed using the shown data repository 831 and/or any forms of network accessible storage. As such, the multiple tiers of storage may include storage that is accessible over communications link 815. Such network accessible storage may include cloud storage or networked storage (e.g., a SAN or storage area network). Unlike prior approaches, the disclosed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In some embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

In some embodiments, any one or more of the aforementioned virtual disks can be structured from any one or more of the storage devices in the storage pool. In some embodiments, a virtual disk is a storage abstraction that is exposed by a controller virtual machine or container to be used by another virtual machine or container. In some embodiments, the virtual disk is exposed by operation of a storage protocol such as iSCSI or NFS or SMB. In some embodiments, a virtual disk is mountable. In some embodiments, a virtual disk is mounted as a virtual storage device.

In some embodiments, some or all of the servers or nodes run virtualization software. Such virtualization software might include a hypervisor (e.g., as shown in configuration 851) to manage the interactions between the underlying hardware and user virtual machines or containers that run client software.

Distinct from user virtual machines or user executable containers, a special controller virtual machine (e.g., as depicted by controller virtual machine instance 830) or as a special controller executable container is used to manage certain storage and I/O activities. Such a special controller virtual machine is sometimes referred to as a controller executable container, a service virtual machine (SVM), a service executable container, or a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 8D is a block diagram illustrating virtualization system architecture 8D00 configured to implement one or more aspects of the present embodiments. As shown in FIG. 8D, virtualization system architecture 8D00 includes a distributed virtualization system that includes multiple clusters (e.g., cluster 883₁, . . . , cluster 883_{N}) comprising multiple nodes that have multiple tiers of storage in a storage pool. Representative nodes (e.g., node 881₁₁, . . . , node 881_{1M}) and storage pool 890 associated with cluster 883₁ are shown. Each node can be associated with one server, multiple servers, or portions of a server. The nodes can be associated (e.g., logically and/or physically) with the clusters. As shown, the multiple tiers of storage include storage that is accessible through a network 896, such as a networked storage 886 (e.g., a storage area network or SAN, network attached storage or NAS, etc.). The multiple tiers of storage further include instances of local storage (e.g., local storage 891₁₁, . . . , local storage 891_{1M}). For example, the local storage can be within or directly attached to a server and/or appliance associated with the nodes. Such local storage can include solid state drives (SSD 893₁₁, . . . , SSD 893_{1M}), hard disk drives (HDD 894₁₁, . . . , HDD 894_{1M}), and/or other storage devices.

As shown, any of the nodes of the distributed virtualization system can implement one or more user virtualized entities (e.g., VE 888₁₁₁, . . . , VE 888_{11K}, . . . , VE 888_{1M1}, . . . , VE 888_{1MK}), such as virtual machines (VMs) and/or executable containers. The VMs can be characterized as software-based computing “machines” implemented in a container-based or hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 887₁₁, . . . , host operating system 887_{1M}), while the VMs run multiple applications on various respective guest operating systems. Such flexibility can be facilitated at least in part by a hypervisor (e.g., hypervisor 885₁₁, . . . , hypervisor 885_{1M}), which hypervisor is logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers are implemented at the nodes in an operating system virtualization environment or container virtualization environment. The executable containers can include groups of processes and/or resources (e.g., memory, CPU, disk, etc.) that are isolated from the node host computer and other containers. Such executable containers directly interface with the kernel of the host operating system (e.g., host operating system 887₁₁, . . . , host operating system 887_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 890 by the VMs and/or the executable containers.

Multiple instances of such virtualized controllers can coordinate within a cluster to form the distributed storage system 892 which can, among other operations, manage the storage pool 890. This architecture further facilitates efficient scaling in multiple dimensions (e.g., in a dimension of computing power, in a dimension of storage space, in a dimension of network bandwidth, etc.).

In some embodiments, a particularly configured instance of a virtual machine at a given node can be used as a virtualized controller in a hypervisor-assisted virtualization environment to manage storage and I/O (input/output or IO) activities of any number or form of virtualized entities. For example, the virtualized entities at node 881₁₁ can interface with a controller virtual machine (e.g., virtualized controller 882₁₁) through hypervisor 885₁₁ to access data of storage pool 890. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 892. For example, a hypervisor at one node in the distributed storage system 892 might correspond to software from a first vendor, and a hypervisor at another node in the distributed storage system 892 might correspond to a second software vendor. As another virtualized controller implementation example, executable containers can be used to implement a virtualized controller (e.g., virtualized controller 882_{1M}) in an operating system virtualization environment at a given node. In this case, for example, the virtualized entities at node 881_{1M} can access the storage pool 890 by interfacing with a controller container (e.g., virtualized controller 882_{1M}) through hypervisor 885_{1M} and/or the kernel of host operating system 887_{1M}.

In some embodiments, one or more instances of an agent can be implemented in the distributed storage system 892 to facilitate the herein disclosed techniques. Specifically, agent 884₁₁ can be implemented in the virtualized controller 882₁₁, and agent 884_{1M} can be implemented in the virtualized controller 882_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

In sum, techniques are disclosed for generating rules from natural-language expressions. An expression engine processes, by a machine learning model, a natural-language expression to generate one or more rules, each rule including one or more triggers and one or more actions. The expression engine can store the one or more rules in a rule set 118. A monitoring engine monitors an infrastructure to detect an occurrence of the one or more triggers of each rule of the one or more rules. Based on detecting an occurrence of one or more triggers in one of the one or more rules, the monitoring engine performs the one or more actions of the corresponding rule. Monitoring the one or more triggers of each rule of the rules and performing the one or more actions of the corresponding rules enables the monitoring engine to fulfill the instructions indicated by the natural-language expressions processed to create the one more rules and thus, manage the corresponding infrastructure.

At least one technical advantage of the disclosed techniques relative to the prior art is that, with the disclosed techniques, rules for monitoring a deployed infrastructure can be specified using natural-language expressions. By processing natural-language expressions to generate the rules, the machine learning model enables users to configure the rules of a monitoring engine for monitoring a deployed infrastructure using natural-language expressions, instead of more complex languages with which users might not be familiar. As a result, the rules can be created, reviewed, and updated more intuitively and naturally by administrators of the deployed infrastructure. Further, with the disclosed techniques, the machine learning model can accurately generate rules by processing natural-language expressions, whereas rules specified through programming language instructions or forms might include errors due to the complex format in which the rules are specified. Finally, processing natural-language expressions by a machine learning model can enable the rules to be specified based on the particular details of the deployed infrastructure (e.g., particular types of queries that arise within the infrastructure), whereas static or generic processing of natural-language expressions might be generically processed without accounting for such details. These technical advantages provide one or more technological improvements over prior art approaches.

1. In some embodiments, one or more non-transitory computer-readable media store program instructions that, when executed by one or more processors, cause the one or more processors to perform a method comprising: processing, by a machine learning model, a natural-language expression to generate one or more rules, each rule including one or more triggers and one or more actions; monitoring a deployed infrastructure to detect an occurrence of at least one of the one or more triggers of a first rule of the one or more rules; and performing at least one of the one or more actions of the first rule based on the occurrence of at least one of the one or more triggers.

2. The one or more non-transitory computer-readable media of clause 1, wherein monitoring the deployed infrastructure includes one or more of: monitoring a current resource utilization of one or more nodes of the deployed infrastructure, monitoring a resource exhaustion of one or more resources of the deployed infrastructure, monitoring a schedule of one or more applications or services executed by one or more nodes of the deployed infrastructure, monitoring a performance of one or more services executed by one or more nodes of the deployed infrastructure, or monitoring a latency of one or more services executed by one or more nodes of the deployed infrastructure.

3. The one or more non-transitory computer-readable media of clauses 1 or 2, wherein the method further comprises further training a pretrained machine learning model based on a training data set associated with the deployed infrastructure.

4. The one or more non-transitory computer-readable media of any of clauses 1-3, wherein the machine learning model classifies each token of one or more tokens of the natural-language expression as a trigger token or an action token.

5. The one or more non-transitory computer-readable media of any of clauses 1-4, wherein the machine learning model determines, for each token of the natural-language expression, a confidence score indicating a classification confidence of the token as being one of a trigger token or an action token.

6. The one or more non-transitory computer-readable media of any of clauses 1-5, wherein the machine learning model segments the natural-language expression into one or more trigger portions of the natural-language expression and one or more action portions of the natural-language expression.

7. The one or more non-transitory computer-readable media of any of clauses 1-6, wherein the machine learning model translates one or more trigger tokens of the natural-language expression into at least one trigger of the one or more triggers of one or more rules, and the machine learning model translates one or more action tokens of the natural-language expression into the one or more actions of one or more rules.

8. The one or more non-transitory computer-readable media of any of clauses 1-7, wherein the machine learning model includes a filter that excludes, from the natural-language expression, one or more tokens of the natural-language expression that are not classified as a trigger token or an action token.

9. In some embodiments, a system comprises: a memory that stores instructions, and a processor that is coupled to the memory and, when executing the instructions, is configured to: process, by a machine learning model, a natural-language expression to generate one or more rules, each rule including a trigger and one or more actions; monitor an infrastructure to detect an occurrence of at least one of the one or more triggers of a first rule of the one or more rules; and perform at least one of the one or more actions of the first rule based on the occurrence of at least one of the one or more triggers.

10. The system of clause 9, wherein monitoring the deployed infrastructure includes one or more of: monitoring a current resource utilization of one or more nodes of the deployed infrastructure, monitoring a resource exhaustion of one or more resources of the deployed infrastructure, monitoring a schedule of one or more applications or services executed by one or more nodes of the deployed infrastructure, monitoring a performance of one or more services executed by one or more nodes of the deployed infrastructure, or monitoring a latency of one or more services executed by one or more nodes of the deployed infrastructure.

11. The system of clauses 9 or 10, wherein the instructions further configure the processor to train a pretrained machine learning model based on a training data set associated with the deployed infrastructure.

12. The system of any of clauses 9-11, wherein the machine learning model classifies each token of one or more tokens of the natural-language expression as a trigger token or an action token.

13. The system of any of clauses 9-12, wherein the machine learning model determines, for each token of the natural-language expression, a confidence score indicating a classification confidence of the token as being one of a trigger token or an action token.

14. The system of any of clauses 9-13, wherein the machine learning model segments the natural-language expression into one or more trigger portions of the natural-language expression and one or more action portions of the natural-language expression.

15. The system of any of clauses 9-14, wherein the machine learning model translates one or more trigger tokens of the natural-language expression into the one or more triggers of one or more rules, and the machine learning model translates one or more action tokens of the natural-language expression into the one or more actions of one or more rules.

16. The system of any of clauses 9-15, wherein the machine learning model includes a filter that excludes, from the natural-language expression, one or more tokens of the natural-language expression that are not classified as a trigger token or an action token.

17. The system of any of clauses 9-16, wherein the machine learning model generates, from the natural-language expression, a first rule including one or more triggers and a first action, and a second rule including one or more triggers and a second action.

18. The system of any of clauses 9-17, wherein the machine learning model generates, from the natural-language expression, a first rule including a first trigger and the one or more actions, and a second rule including a second trigger and the one or more actions.

19. The system of any of clauses 9-18, wherein the instructions further configure the processor to retrain the machine learning model based on a failure of the machine learning model to generate one or more rules for the natural-language expression, wherein the retraining is based on the expression and a provided one or more rules.

20. In some embodiments, a method comprises: processing, by a machine learning model, a natural-language expression to generate one or more rules, each rule including a trigger and one or more actions; monitoring an infrastructure to detect an occurrence of at least one of the one or more triggers of a first rule of the one or more rules; and performing at least one of the one or more actions of the first rule based on the occurrence of at least one of the one or more triggers.

21. The method of clause 20, wherein monitoring the deployed infrastructure includes one or more of: monitoring a current resource utilization of one or more nodes of the deployed infrastructure, monitoring a resource exhaustion of one or more resources of the deployed infrastructure, monitoring a schedule of one or more applications or services executed by one or more nodes of the deployed infrastructure, monitoring a performance of one or more services executed by one or more nodes of the deployed infrastructure, or monitoring a latency of one or more services executed by one or more nodes of the deployed infrastructure.

22. The method of clauses 20 or 21, wherein the method further comprises further training a pretrained machine learning model based on a training data set associated with the deployed infrastructure.

23. The method of any of clauses 20-22, wherein the machine learning model classifies each token of one or more tokens of the natural-language expression as a trigger token or an action token.

24. The method of any of clauses 20-23, wherein the machine learning model determines, for each token of the natural-language expression, a confidence score indicating a classification confidence of the token as being one of a trigger token or an action token.

25. The method of any of clauses 20-24, wherein the machine learning model segments the natural-language expression into one or more trigger portions of the natural-language expression and one or more action portions of the natural-language expression.

26. The method of any of clauses 20-25, wherein the machine learning model translates one or more trigger tokens of the natural-language expression into one or more triggers of one or more rules, and the machine learning model translates one or more action tokens of the natural-language expression into the one or more actions of one or more rules.

27. The method of any of clauses 20-26, wherein the machine learning model includes a filter that excludes, from the natural-language expression, one or more tokens of the natural-language expression that are not classified as a trigger token or an action token.

28. The method of any of clauses 20-27, wherein the machine learning model generates, from the natural-language expression, a first rule including the one or more triggers and a first action, and a second rule including the one or more triggers and a second action.

29. The method of any of clauses 20-28, wherein the machine learning model generates, from the natural-language expression, a first rule including a first trigger and the one or more actions, and a second rule including a second trigger and the one or more actions.

30. The method of any of clauses 20-29, further comprising, retraining the machine learning model based on a failure of the machine learning model to generate one or more rules for the natural-language expression, wherein the retraining is based on the expression and a provided one or more rules.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, for example, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. One or more non-transitory computer-readable media storing program instructions that, when executed by one or more processors, cause the one or more processors to perform a method comprising:
processing, by a machine learning model, a natural-language expression to generate one or more rules, each rule including one or more triggers and one or more actions;
monitoring a deployed infrastructure to detect an occurrence of at least one of the one or more triggers of a first rule of the one or more rules; and
performing at least one of the one or more actions of the first rule based on the occurrence of at least one of the one or more triggers.

2. The one or more non-transitory computer-readable media of claim 1, wherein monitoring the deployed infrastructure includes one or more of:
monitoring a current resource utilization of one or more nodes of the deployed infrastructure,
monitoring a resource exhaustion of one or more resources of the deployed infrastructure,
monitoring a schedule of one or more applications or services executed by one or more nodes of the deployed infrastructure,
monitoring a performance of one or more services executed by one or more nodes of the deployed infrastructure, or
monitoring a latency of one or more services executed by one or more nodes of the deployed infrastructure.

3. The one or more non-transitory computer-readable media of claim 1, wherein the method further comprises further training a pretrained machine learning model based on a training data set associated with the deployed infrastructure.

4. The one or more non-transitory computer-readable media of claim 1, wherein the machine learning model classifies each token of one or more tokens of the natural-language expression as a trigger token or an action token.

5. The one or more non-transitory computer-readable media of claim 1, wherein the machine learning model determines, for each token of the natural-language expression, a confidence score indicating a classification confidence of the token as being one of a trigger token or an action token.

6. The one or more non-transitory computer-readable media of claim 1, wherein the machine learning model segments the natural-language expression into one or more trigger portions of the natural-language expression and one or more action portions of the natural-language expression.

7. The one or more non-transitory computer-readable media of claim 1, wherein the machine learning model translates one or more trigger tokens of the natural-language expression into at least one trigger of the one or more triggers of one or more rules, and the machine learning model translates one or more action tokens of the natural-language expression into the one or more actions of one or more rules.

8. The one or more non-transitory computer-readable media of claim 1, wherein the machine learning model includes a filter that excludes, from the natural-language expression, one or more tokens of the natural-language expression that are not classified as a trigger token or an action token.

9. A system, comprising:
a memory that stores instructions, and
a processor that is coupled to the memory and, when executing the instructions, is configured to:
process, by a machine learning model, a natural-language expression to generate one or more rules, each rule including a trigger and one or more actions;
monitor an infrastructure to detect an occurrence of at least one of the one or more triggers of a first rule of the one or more rules; and
perform at least one of the one or more actions of the first rule based on the occurrence of at least one of the one or more triggers.

10. The system of claim 9, wherein monitoring the infrastructure includes one or more of,
monitoring a current resource utilization of one or more nodes of the infrastructure,
monitoring a resource exhaustion of one or more resources of the infrastructure,
monitoring a schedule of one or more applications or services executed by one or more nodes of the infrastructure,
monitoring a performance of one or more services executed by one or more nodes of the infrastructure, or
monitoring a latency of one or more services executed by one or more nodes of the infrastructure.

11. The system of claim 9, wherein the instructions further configure the processor to train a pretrained machine learning model based on a training data set associated with the infrastructure.

12. The system of claim 9, wherein the machine learning model classifies each token of one or more tokens of the natural-language expression as a trigger token or an action token.

13. The system of claim 9, wherein the machine learning model determines, for each token of the natural-language expression, a confidence score indicating a classification confidence of the token as being one of a trigger token or an action token.

14. The system of claim 9, wherein the machine learning model segments the natural-language expression into one or more trigger portions of the natural-language expression and one or more action portions of the natural-language expression.

15. The system of claim 9, wherein the machine learning model translates one or more trigger tokens of the natural-language expression into the one or more triggers of one or more rules, and the machine learning model translates one or more action tokens of the natural-language expression into the one or more actions of one or more rules.

16. The system of claim 9, wherein the machine learning model includes a filter that excludes, from the natural-language expression, one or more tokens of the natural-language expression that are not classified as a trigger token or an action token.

17. The system of claim 9, wherein the machine learning model generates, from the natural-language expression,
a first rule including one or more triggers and a first action, and
a second rule including one or more triggers and a second action.

18. The system of claim 9, wherein the machine learning model generates, from the natural-language expression,
a first rule including a first trigger and the one or more actions, and
a second rule including a second trigger and the one or more actions.

19. The system of claim 9, wherein the instructions further configure the processor to retrain the machine learning model based on a failure of the machine learning model to generate one or more rules for the natural-language expression, wherein the retraining is based on the natural language expression and a provided one or more rules.

20. A method comprising:
processing, by a machine learning model, a natural-language expression to generate one or more rules, each rule including a trigger and one or more actions;
monitoring an infrastructure to detect an occurrence of at least one of the one or more triggers of a first rule of the one or more rules; and
performing at least one of the one or more actions of the first rule based on the occurrence of at least one of the one or more triggers.

21. The method of claim 20, wherein monitoring the deployed infrastructure includes one or more of,
monitoring a current resource utilization of one or more nodes of the deployed infrastructure,
monitoring a resource exhaustion of one or more resources of the deployed infrastructure,
monitoring a schedule of one or more applications or services executed by one or more nodes of the deployed infrastructure,
monitoring a performance of one or more services executed by one or more nodes of the deployed infrastructure, or
monitoring a latency of one or more services executed by one or more nodes of the deployed infrastructure.

22. The method of claim 20, wherein the method further comprises further training a pretrained machine learning model based on a training data set associated with the infrastructure.

23. The method of claim 20, wherein the machine learning model classifies each token of one or more tokens of the natural-language expression as a trigger token or an action token.

24. The method of claim 20, wherein the machine learning model determines, for each token of the natural-language expression, a confidence score indicating a classification confidence of the token as being one of a trigger token or an action token.

25. The method of claim 20, wherein the machine learning model segments the natural-language expression into one or more trigger portions of the natural-language expression and one or more action portions of the natural-language expression.

26. The method of claim 20, wherein the machine learning model translates one or more trigger tokens of the natural-language expression into one or more triggers of one or more rules, and the machine learning model translates one or more action tokens of the natural-language expression into the one or more actions of one or more rules.

27. The method of claim 20, wherein the machine learning model includes a filter that excludes, from the natural-language expression, one or more tokens of the natural-language expression that are not classified as a trigger token or an action token.

28. The method of claim 20, wherein the machine learning model generates, from the natural-language expression,
a first rule including the one or more triggers and a first action, and
a second rule including the one or more triggers and a second action.

29. The method of claim 20, wherein the machine learning model generates, from the natural-language expression,
a first rule including a first trigger and the one or more actions, and
a second rule including a second trigger and the one or more actions.

30. The method of claim 20, further comprising retraining the machine learning model based on a failure of the machine learning model to generate one or more rules for the natural-language expression, wherein the retraining is based on the natural language expression and a provided one or more rules.
